(19) United States
(12) Patent Application Publication
(10) Pub. No.: US 2011/0067329 A1
(43) Pub. Date: Mar. 24, 2011

(54) Strap For Use In Shutter Installations And Method Of Using The Same

(76) Inventors: Jerry Lawrence Myny, Algonac, MI (US); Donee Lois Myny, Algonac, MI (US)

(21) Appl. No.: 12/564,869

(22) Filed: Sep. 22, 2009

(51) Int. Cl. E06B 3/26; E06B 9/02

(52) U.S. Cl. 52/202; 52/745.15

(57) ABSTRACT

A strap for securing a shutter to a track using bolts and fasteners, the track having a thickness and width for receiving the bolts, the shutter being used to protect a building opening, and the strap comprising: a rectangular-shaped flexible material; and a plurality of openings within the material for holding the bolts, wherein the openings are equidistant from each other and the same size. The shutters are typically used to protect windows and doors during periods of bad weather. The shutters may also be used for security purposes.

### BACKGROUND OF THE INVENTION

A shutter is used to protect a building opening such as a door or window during severe weather. The shutter may also be used for security. There are many different types of mounting brackets used for shutter installation. One method of mounting the shutter is to install track on the sides of the opening. Then, bolts are placed in the track by sliding one bolt at a time by hand, the shutter is mounted on the bolts, and the shutter is secured with wing nuts.

### BRIEF SUMMARY OF THE INVENTION

The present disclosure provides a strap for use in mounting shutters. The strap enables bolts to be installed in a track, positioned, and held in place during shutter mounting. The shutters are typically used to protect windows and doors during periods of bad weather. The shutters may also be used for security purposes.

The strap has properly sized openings to match the size of the bolts. The strap openings are also properly spaced to match the shutter openings. The bolts are threaded into the openings instead of being pushed through. Threading minimizes damage to the strap opening and enables the strap to better hold the bolt in place. The bolts are not fully threaded, so that a gap is left between the bolt head and the strap.

The bolt heads are individually slid into the track and the strap is used to pull the bolts into the proper position to receive the shutter. The shutter is mounted on the bolts and then secured with fasteners such as wing nuts.

### BRIEF DESCRIPTION OF THE DRAWINGS

FIG. 1 shows a side view with bolts threaded into a strap.

FIG. 2 shows a side view of a vertical shutter installation.

FIG. 3 shows an exploded view of a horizontal shutter installation.

### DETAILED DESCRIPTION OF THE INVENTION

A shutter is used to protect a building opening such as a door or window during severe weather. The shutter may also be used for security. There are many different types of mounting brackets used for shutter installation. One method of mounting the shutter is to install track on the sides of the opening. Then, bolts are placed in the track by sliding one bolt at a time by hand, the shutter is mounted on the bolts, and the shutter is secured with wing nuts.

One problem with the above method is that the bolts are loose in the track. Hence, the bolts may not lie perpendicular to the building and may not easily fit into shutter mounting holes. The problem is especially acute in vertical installations where gravity forces the bolts to slide downward in the track. Therefore, mounting the shutters requires at least one additional person to simply hold the bolts in place.

The present disclosure solves the above problem with a strap for use in mounting shutters. The strap enables bolts to be installed in a track and held in place during shutter mounting. Therefore, no one is required to hold the bolts in place during shutter mounting. The strap also saves installation time and is more efficient when time is of the essence with a storm imminent. It allows one person to install storm shutters when no other individual is available to help.

One unexpected result of using the strap is that it prevents metal on metal wear, scratching, and nicking.

Another unexpected result of using the strap is that the shutters are much quieter in bad weather. This is because the amount of “metal on metal” contact is reduced.

Another unexpected result is that the strap may be easily stored with the bolts installed. This saves time every time that the shutters are reinstalled, after the first installation.

The present disclosure describes an article of manufacture which comprises a strap designed for shutter mounting. The strap has properly sized openings to match the size of the bolts used to mount the shutter. The strap openings are also properly spaced to match the shutter openings. The strap has a thickness between 1/64″ and ½″ an inch. The thickness affects the ease of holding the bolts in place. The strap comprises a flexible material including leather, nylon, polypropylene, cloth, or the like. Strap lengths can vary since the strap is cut during installation to match the length of track. The strap holes may be reinforced with grommets or strengthened with a coating to minimize wear from installing and removing bolts.

Directions for using the present invention in a vertical installation are as follows. First, mount track onto the building on both sides of the building opening. Second, cut the strap to match the length of the track. Third, thread bolts through holes, leaving a 1/16 inch gap between the head of the bolts and the strap. Fourth, start at the top of the track, install the bolt heads in the track, and slide them down the track until all of the slack is taken out of the strap. Fifth, secure the uppermost bolt with a fastener at the proper height for shutter installation. Sixth, repeat the second through the fifth steps for the other side of the building opening. Make sure that the bolts on both sides of the building opening are aligned at the same height. Seventh, place a shutter on the three (3) lowest bolts and secure a fastener onto the center bolt of both sides of the shutter. Eighth, secure fasteners onto the remaining bolts of the lowermost shutter. Ninth, install additional shutters. Tenth, prior to installing the final shutter, remove fastener from the uppermost bolt.

Directions for using the present invention in a horizontal installation are as follows. First, mount track onto the building on both sides of the building opening. Second, cut the strap to match the length of the track. Note that if the strap is too short, more than one strap may be used in series by overlapping the end bolt and the added strap. Third, thread bolts through holes, leaving a 1/16 inch gap between the head of the bolts and the strap. Fourth, install the bolt heads in the track and slide them across the track until all of the slack is taken out of the strap. Sixth, repeat the second through the fourth steps for the other side of the building opening. Make sure that the bolts on both sides of the building opening are aligned. Seventh, place a shutter on three (3) bolts and secure a fastener onto the center bolt of both sides of the shutter. Eighth, secure fasteners onto the remaining bolts of the first shutter. Ninth, install additional shutters.

Note that it is possible for a shutter to have more or less than three (3) shutter openings. In that case, the above directions would be modified accordingly.

While descriptions of vertical and horizontal installations are given above, the descriptions are not meant to be limiting. Shutter installations may occur in many angles and positions, being limited only by the location of building openings which must be protected.

The track structure includes an elongated track or rail having a rear surface, a front face, and top and bottom edges. The track further includes an elongated channel formed along a length of the track between the rear surface and front face. An elongated slot extends along the front face, exposing the channel and permitting access thereto.

Many different types of track may be used. In one embodiment, a track commonly known as “F” track is used.

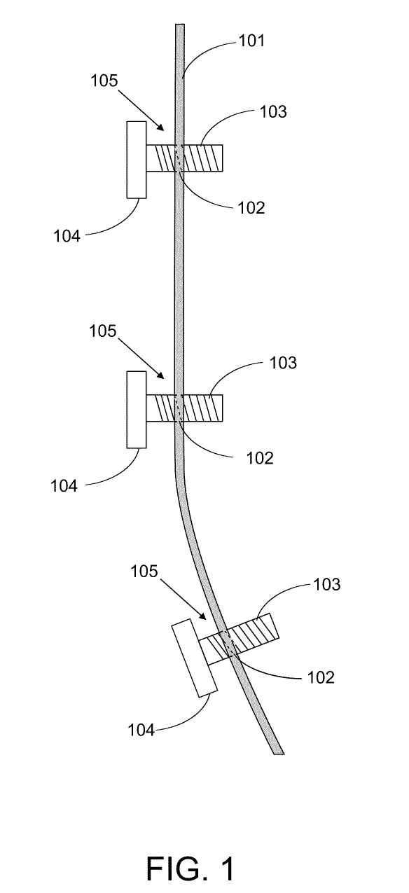

FIG. 1 shows a side view with bolts threaded into a strap. The strap 101 has a plurality of openings 102. The bolts 103 are threaded into the strap openings 102. A gap 105 exists between each bolt head 104 and the strap 101.

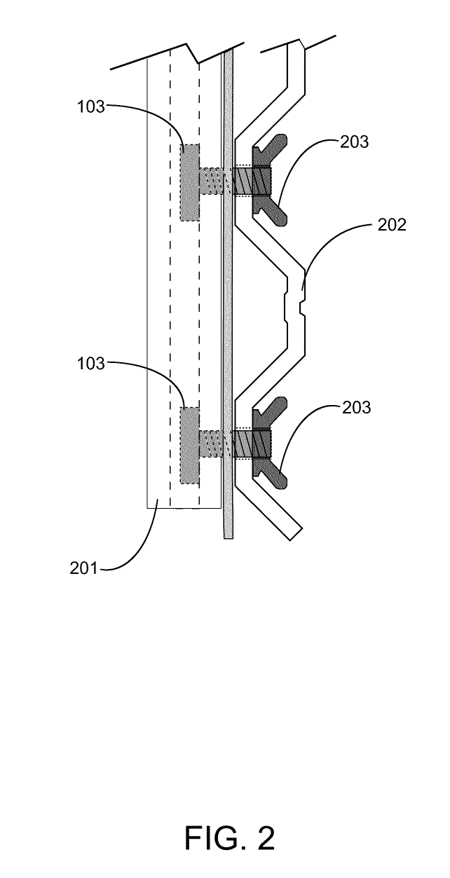

FIG. 2 shows a side view of a vertical shutter installation. The bolts 103 sit in a track 201. The bolts 103 are held in position with the strap 101 which is adjacent to the track 201. A shutter 202 is mounted on the bolts 103 and is adjacent to the strap 101. The shutter 202 is secured with fasteners 203 which thread onto the bolts 103. In this example, the fasteners 203 are wing nuts but many types of fasteners are possible.

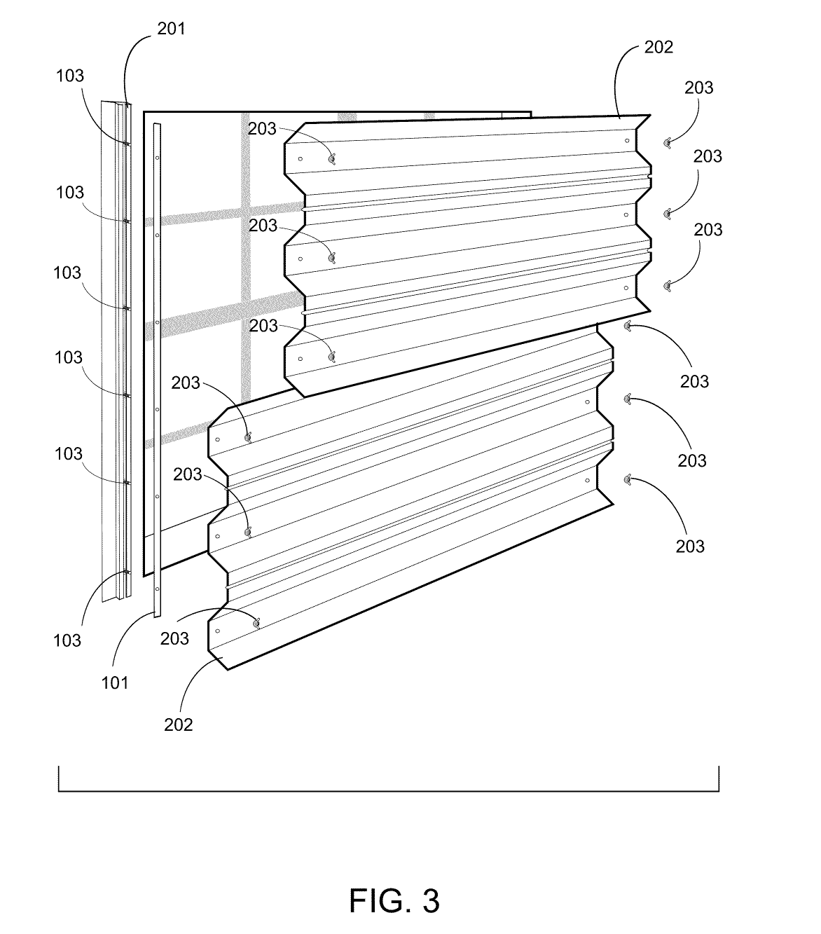

FIG. 3 shows an exploded isometric view of a horizontal shutter installation. The bolts 103 sit in a track 201. The bolts 103 are held in position with the strap 101 which is adjacent to the track 201. A shutter 202 is mounted on the bolts 103 and is adjacent to the strap 101. The shutter 202 is secured with fasteners 203 which thread onto the bolts 103. In this example, the fasteners 203 are wing nuts but many types of fasteners are possible.

While the present invention has been described herein with reference to an embodiment and various alternatives thereto, it should be apparent that the invention is not limited to such embodiments. Rather, many variations would be apparent to persons of skill in the art without departing from the scope and spirit of the invention, as defined herein and in the claims.

We claim:

1. (canceled)

2. (canceled)

3. (canceled)

4. (canceled)

5. (canceled)

6. (canceled)

7. A method for using a strap to secure a shutter to a track using bolts and fasteners, the track having a thickness and width for receiving the bolts, the shutter being used to protect a building opening, and the method comprising:
using a rectangular-shaped flexible material; and
using a plurality of openings within the material for holding the bolts, wherein the openings within the material are equidistant from each other and the same size.

8. A strap for securing a shutter to a track using bolts and fasteners, the track having a thickness and width for receiving the bolts, the shutter being used to protect a building opening, and the strap comprising:
a rectangular-shaped flexible material; and
a plurality of openings within the material for holding the bolts, wherein the openings within the material are equidistant from each other and the same size.

9. The strap of claim 8, wherein the bolts are inserted in the openings within the material.

10. The strap of claim 8, wherein the bolts are inserted in the openings within the material and the bolts are mounted in the track.

11. The strap of claim 8, wherein the bolts are inserted in the openings within the material, the bolts are mounted in the track, and the shutter is mounted on the bolts.

12. The strap of claim 8, wherein the bolts are inserted in the openings within the material, the bolts are mounted in the track, the shutter is mounted on the bolts, and the fasteners are used to secure the shutter.
